(19) United States
(12) Patent Application Publication
(10) Pub. No.: US 2026/0339673 A1
(43) Pub. Date: Oct. 29, 2026

(54) MANAGING THERMAL POLICY AT AN INFORMATION HANDLING SYSTEM

(71) Applicant: Dell Products L.P., Round Rock, TX (US)

(72) Inventors: Ting-Chiang Huang, New Taipei City (TW); Qinghong He, Austin, TX (US); Kai-Po Chang, New Taipei City (TW); Yen-Ming Chen, New Taipei City (TW)

(21) Appl. No.: 19/190,909

(22) Filed: Apr. 28, 2025

(51) Int. Cl. G06F 9/4401; G05B 19/4155

(52) U.S. Cl. CPC G06F 9/4401; G05B 19/4155; G05B 2219/49216

(57) ABSTRACT

Managing thermal policy, including: detecting boot of an information handling system; in response to detecting the boot of the information handling system, performing thermal policy management at the information handling system, including: determining whether the information handling system is associated with a previous thermal policy based on a thermal diffusivity of cooling components of the information handling system; determining that the information handling system is not associated with a previous thermal policy, and in response: determining a particular temperature rise curve of a processor of the information handling system; identifying a particular thermal diffusivity associated with the particular temperature rise curve; identifying a particular thermal policy associated with the particular thermal diffusivity; applying the particular thermal policy at the information handling system, including: adjusting, based on the particular thermal policy, parameters of the cooling components and the processor; operating the cooling components and the processor based on the adjusted parameters.

### BACKGROUND

### FIELD OF THE DISCLOSURE

The disclosure relates generally to an information handling system, and in particular, managing thermal policy at the information handling system.

### DESCRIPTION OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Temperature control in an information handling system is crucial for maintaining optimal performance and preventing hardware damage. Information handling systems use cooling systems like fans, heat sinks, and liquid cooling to dissipate heat generated by components such as the CPU and GPU. Monitoring software can track temperature levels and adjust fan speeds accordingly to ensure efficient cooling. Proper temperature management helps extend the lifespan of computer components and ensures stable operation.

### SUMMARY

Innovative aspects of the subject matter described in this specification may be embodied in a method of managing thermal policy at an information handling system, including detecting a boot of the information handling system; in response to detecting the boot of the information handling system, performing thermal policy management at the information handling system, including: determining whether the information handling system is associated with a previous thermal policy based on a thermal diffusivity of cooling components of the information handling system; determining that the information handling system is not associated with a previous thermal policy, and in response: determining a particular temperature rise curve of a processor of the information handling system; identifying a particular thermal diffusivity associated with the particular temperature rise curve; identifying a particular thermal policy associated with the particular thermal diffusivity; applying the particular thermal policy at the information handling system, including: adjusting, based on the particular thermal policy, parameters of the cooling components and the processor; and operating the cooling components and the processor based on the adjusted parameters.

Other embodiments of these aspects include corresponding systems, apparatus, and computer programs, configured to perform the actions of the methods, encoded on computer storage devices.

These and other embodiments may each optionally include one or more of the following features. For instance, receiving user input indicating to perform the thermal policy management at the information handling system, and in response, performing the thermal policy management at the information handling system. Receiving user input indicating to maintain default thermal policy management at the information handling system, and in response, maintaining the default thermal policy management at the information handling system. Determining that the information handling system is associated with a previous thermal policy, and in response: applying the previous thermal policy at the information handling system, including: adjusting, based on the previous thermal policy, parameters of the cooling components and the processor; operating the cooling components and the processor based on the adjusted parameters; and updating a table to indicate the previous thermal policy as the current thermal policy. Updating a table to indicate the particular thermal policy as the current thermal policy. After updating the table, determining whether to maintain the particular thermal policy as a current thermal policy of the information handling system; determining to maintain the particular thermal policy as a current thermal policy of the information handling system, and in response, maintaining the particular thermal policy at the information handling system until a subsequent boot of the information handling system. After updating the table, determining whether to maintain the particular thermal policy as a current thermal policy of the information handling system; determining to not maintain the particular thermal policy as a current thermal policy of the information handling system, and in response, reverting to a default thermal policy at the information handling system until a subsequent boot of the information handling system.

Particular implementations of the subject matter described in this specification can be implemented so as to realize one or more of the following advantages. For example, gaining additional turbo time (Tau) or increasing additional percentage settings of PL2 power along with performance gains.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for managing thermal policy at the information handling system.

FIG. 3 illustrates a method for managing thermal policy at the information handling system.

FIG. 4 illustrates a graph of an example of a temperature rise curve for a processor of the information handling system.

FIG. 5 illustrates a table of thermal policies for thermal diffusivities.

### DESCRIPTION OF PARTICULAR EMBODIMENT(S)

This disclosure discusses methods and systems for managing thermal policy at an information handling system. In short, a thermal control algorithm enables system performance optimization by leveraging the thermal characteristics of thermal diffusivity of a cooling component of the information handling system. This includes timely thermal solution diffusivity checks once the system boots up, and executing the thermal diffusivity (α) number testing process. The invention facilitates integration of thermal diffusivity and thermal algorithms to enhance system turbo performance. By enhancing system performance through thermal diffusivity, the turbo booster function (PL2) allows a processor to run at maximum frequency during short periods of heavy workload.

Specifically, this disclosure discusses a system and a method for managing thermal policy at an information handling system, including detecting a boot of the information handling system; in response to detecting the boot of the information handling system, performing thermal policy management at the information handling system, including: determining whether the information handling system is associated with a previous thermal policy based on a thermal diffusivity of cooling components of the information handling system; determining that the information handling system is not associated with a previous thermal policy, and in response: determining a particular temperature rise curve of a processor of the information handling system; identifying a particular thermal diffusivity associated with the particular temperature rise curve; identifying a particular thermal policy associated with the particular thermal diffusivity; applying the particular thermal policy at the information handling system, including: adjusting, based on the particular thermal policy, parameters of the cooling components and the processor; and operating the cooling components and the processor based on the adjusted parameters.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

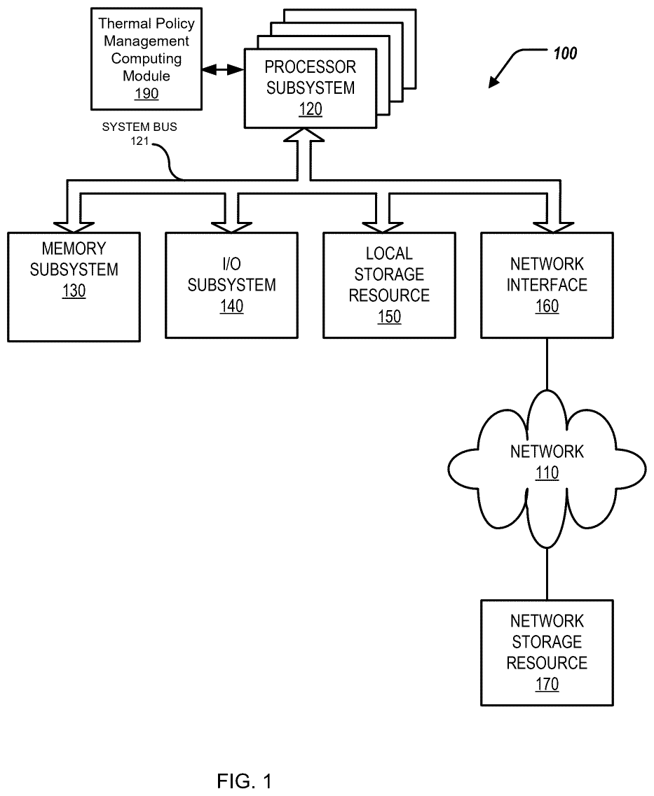

Particular embodiments are best understood by reference to FIGS. 1-5 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system 100). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

The information handling system 100 can also include a thermal policy management computing module 190. The thermal policy management computing module 190 can be in communication with the processor subsystem 120, or included by the processor subsystem 120. In some examples, the thermal policy management computing module 190 is included by an embedded controller (EC) of the information handling system 100. In some examples, the thermal policy management computing module 190 is included by a baseband management controller of the information handling system 100.

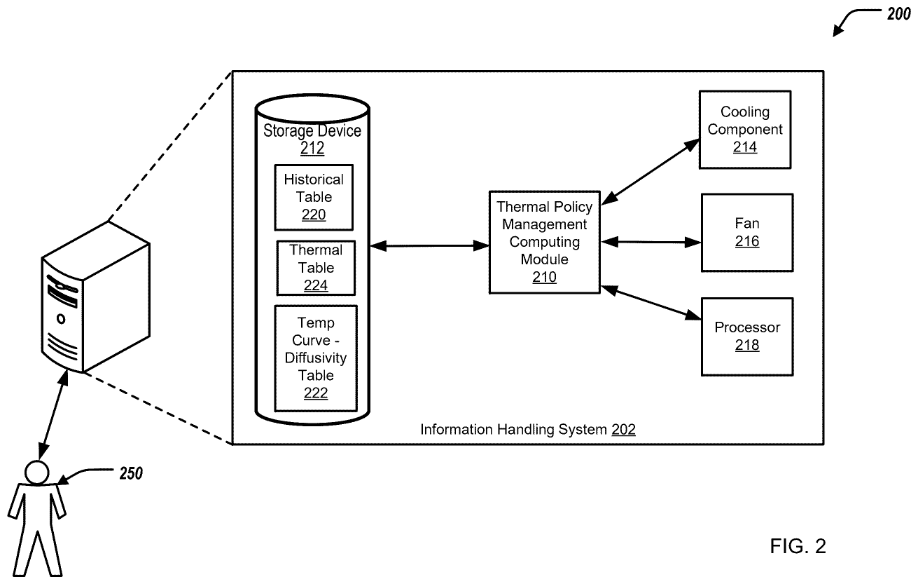

Turning to FIG. 2, FIG. 2 illustrates an environment 200 including an information handling system 202. The information handling system 202 can include a thermal policy management computing module 210, a storage device 212, a cooling component 214, a fan 216, and a processor 218. In some examples, the information handling system 202 is similar to, or includes, the information handling system 100 of FIG. 1. In some examples, the thermal policy management computing module 210 is the same, or substantially the same, as the thermal policy management computing module 190 of FIG. 1.

The thermal policy management computing module 210 can be in communication with the storage device 212, the cooling component 214, the fan 216, and the processor 218.

The cooling component 214 can include a heat pipe, a vapor chamber, or any cooling component (or cooling components) associated with cooling of the information handling system 202, including the processor 218. The cooling component 214 can be associated with a thermal diffusivity. The thermal diffusivity is a material property of the cooling component 214 that indicates a rate at which thermal energy (heat) spreads through the material of the cooling component 214. In other words, the thermal diffusivity of the cooling component 214 is based on the thermal conductivity of the material of the cooling component 214, the specific heat capacity of the material of the cooling component 214, and the density of the material of the cooling component 214. The thermal diffusivity of the cooling component 214 is proportional to the thermal conductivity of the material of the cooling component 214; and inversely proportional to the specific heat capacity of the material of the cooling component 214 and the density of the material of the cooling component 214.

In short, a thermal control algorithm enables system performance optimization by leveraging the thermal characteristics of thermal diffusivity of the cooling component 214. This includes timely thermal solution diffusivity checks once the system boots up, and executing the thermal diffusivity (α) number testing process. The invention facilitates integration of thermal diffusivity and thermal algorithms to enhance system turbo performance. By enhancing system performance through thermal diffusivity, the turbo booster function (PL2) allows the processor 218 to run at maximum frequency during short periods of heavy workload.

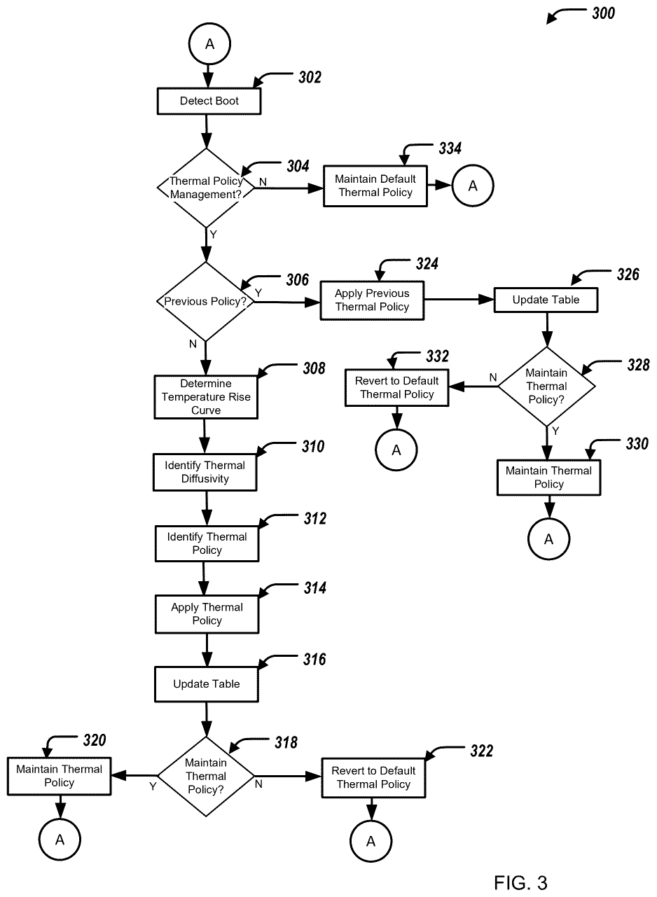

FIG. 3 illustrates a flowchart depicting selected elements of an embodiment of a method 300 for managing thermal policy at the information handling system. The method 300 may be performed by the information handling system 100, the information handling system 202, and/or the thermal policy management computing module 210, and with reference to FIGS. 1-2. It is noted that certain operations described in method 300 may be optional or may be rearranged in different embodiments.

The thermal policy management computing module 210 detects a boot of the information handling system 202, at 302. That is, the information handling system 202 is booted up, and the thermal policy management computing module 210 detects such boot.

The thermal policy management computing module 210 determines whether thermal policy management is to be performed at the information handling system 202, at 304. That is, in response to the detecting the boot of the information handling system 202, the thermal policy management computing module 210 determines whether thermal policy management is to be performed at the information handling system 202. In some examples, a user 250 of the information handling system 202 can provide user input to the information handling system 202 indicating whether to perform thermal policy management at the information handling system 202.

In some examples, the thermal policy management computing module 210 determines that thermal policy management is to be performed at the information handling system 202 (at 304). For example, the user 250 can provide user input indicating to perform the thermal policy management at the information handling system 202. To that end, in response to the thermal policy management computing module 210 determining that thermal policy management is to be performed at the information handling system 202 (at 304), the thermal policy management computing module 210 determines whether the information handling system 202 is associated with a previous thermal policy, at 306. That is, the thermal policy management accesses the historical table 220 of the storage device 212. The historical table 220 can indicate a log of previous thermal policies implemented at the information handling system 202 and during which time periods, including a most recent thermal policy implemented at the information handling system 202. The thermal policy can be based on the thermal diffusivity of the cooling component 214 of the information handling system 202.

In some examples, the thermal policy management computing module 210 determines that the information handling system 202 is not associated with a previous thermal policy (at 306). That is, the thermal policy management computing module 210 determines that the historical table 220 does not include any historical data indicating previous thermal policies at the information handling system 202. In response to the thermal policy management computing module 210 determining that the information handling system 202 is not associated with a previous thermal policy (at 306), the thermal policy management computing module 210 determines a particular temperature rise curve of the processor 218, at 308.

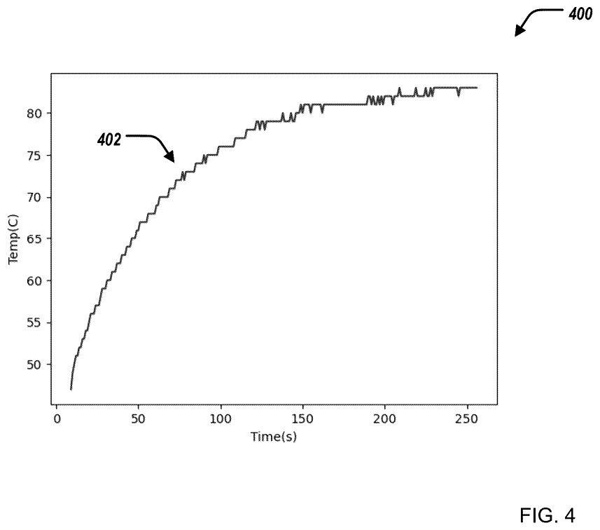

Specifically, the thermal policy management computing module 210 determines the particular temperature rise curve of the processor 218 by i) closing execution of applications (computer-implemented applications, computer-executable applications, computer language applications) at the information handling system 202, ii) adjusting a computing workload of the information handling system 202 to an idle computing workload (the processor 218 is operating at an idle computing workload) (the processor is working at an idle thermal design power), iii) a fan speed of the fan 216 is adjusted to a 50% duty cycle, iv) determining that a temperature of the processor 218 is less than an ambient environment of the computing environment 200 plus a nominal number (e.g., 15 degrees Celsius), and v) increasing the workload at the information handling system 202 to 100% of the thermal design power (TDP). The thermal policy management computing module 210 can then record the temperature of the processor 218 at multiple instances (e.g., every 1 second, 2 seconds, 5 seconds, 10 seconds, 1 minute, etc.). The thermal policy management computing module 210 can generate the particular temperature rise curve of the processor 218 based on the temperature of the processor 218 at multiple instances. That is, the particular temperature rise curve of the processor 218 can include, for each time instance that the temperature is polled of the processor 218, the temperature of the processor 218. FIG. 4 illustrates a graph 400 of an example of the particular temperature rise curve 402 for the processor 218.

The thermal policy management computing module 210 can identify a particular thermal diffusivity associated with the particular temperature rise curve, at 310. Specifically, the thermal policy management computing module 210 accesses the temperature rise curve—diffusivity table 222 stored by the storage device 212. The temperature rise curve—diffusivity table 222 can indicate, for one of many temperature rise curves, a corresponding thermal diffusivity associated with the respective temperature rise curve. In some examples, the corresponding thermal diffusivity can be a range, or a particular number. In some examples, a manufacturer of the cooling component 214 and/or the processor 218 can provide the data indicating the temperature rise curve—diffusivity table 222.

The thermal policy management computing module 210 can compare the particular temperature rise curve (of the processor 218) with the temperature rise curves of the temperature rise curve—diffusivity table 222. The thermal policy management computing module 210, based on such comparison, can identify the particular temperature rise curve of the temperature rise curve—diffusivity table 222, and further, identify the particular thermal diffusivity that is associated with the particular temperature rise curve as indicted by the temperature rise curve—diffusivity table 222.

The thermal policy management computing module 210 can identify a particular thermal policy associated with the particular thermal diffusivity, at 312. Specifically, the thermal policy management computing module 210 accesses the thermal table 224 stored by the storage device 212. The thermal table 224 can indicate, for one of many thermal diffusivities (or ranges of thermal diffusivities), a corresponding thermal policy. The thermal policy management computing module 210 can compare the particular thermal diffusivity (or thermal diffusivity range) with the thermal table 224. The thermal policy management computing module, based on such comparison, can identify the particular thermal diffusivity (or thermal diffusivity range), and further, identify the particular thermal policy that is associated with the particular thermal diffusivity as indicated by the thermal table 224.

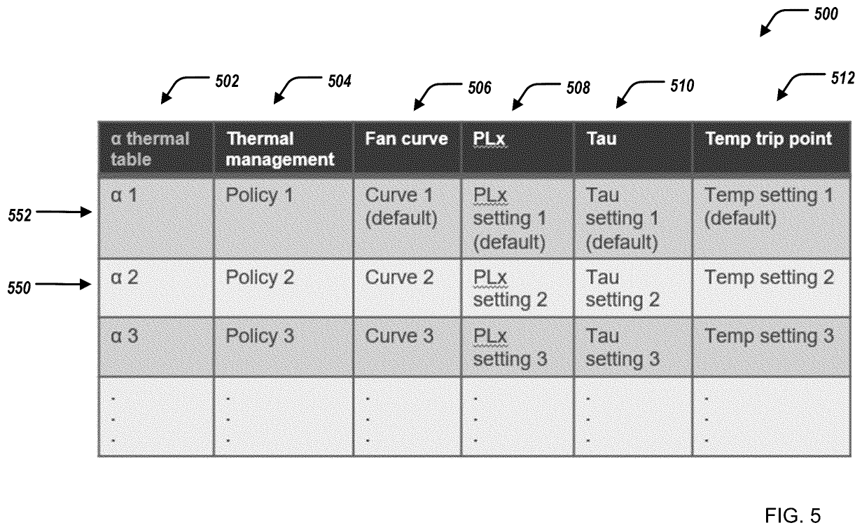

In some examples, the thermal table 224 can further indicate, for each thermal policy, parameters associated with the thermal policy. In some examples, the parameters of the thermal policy can include a fan curve of the fan 216 (fan speed for corresponding temperatures of the processor 218), a power limit 2 (PL2) of the processor 218 (a short-term, turbo power limit of the processor 218), a tau setting (thermal diffusion time constant), and a temperature trip point of the processor 218. FIG. 5 illustrates a table 500, indicating for thermal diffusivities (or ranges of thermal diffusivities) 502, a corresponding thermal management policy 504, and further, a fan curve 506, a PLx (PL2) setting 508, a tau setting 510, and a temperature trip point 512. For example, the particular thermal policy can correspond to row 550.

The thermal policy management computing module 210 applies the particular thermal policy at the information handling system 202, at 314. That is, the thermal policy management computing module 210 applies the particular thermal policy at the information handling system 202, including, applying the fan curve corresponding with the particular thermal policy, updating the PL2 of the processor 218 corresponding with the particular thermal policy, applying the tau setting corresponding with the particular thermal policy, and applying the temperature trip point corresponding with the particular thermal policy.

In some examples, when the thermal policy management computing module 210 applies the particular thermal policy at the information handling system 202, the thermal policy management computing module 210 adjusts parameters of the cooling component 214, the fan 216, and/or the processor 218. The thermal policy management computing module 210 adjusts the fan curve to correspond with the particular thermal policy, updating the PL2 of the processor 218 to correspond with the particular thermal policy, applying the tau setting to correspond with the particular thermal policy, and applies the temperature trip point to correspond with the particular thermal policy.

Moreover, in some examples, the cooling component 214, the fan 216, and/or the processor 218 operates based on the adjusted parameters. That is, the cooling component 214, the fan 216, and/or the processor 218 operates based on the fan curve corresponding with the particular thermal policy, the PL2 of the processor 218 corresponding with the particular thermal policy, the tau setting corresponding with the particular thermal policy, and the temperature trip point corresponding with the particular thermal policy.

The thermal policy management computing module 210 updates the historical table 220, at 316. Specifically, the thermal policy management computing module 210 updates the historical table 220 to indicate the particular thermal policy as the current thermal policy of the information handling system 202. In other words, the thermal policy management computing module 210 updates the historical table 220 to indicate the particular thermal policy as the most recent thermal policy implemented at the information handling system 202.

The thermal policy management computing module 210, after updating the historical table 220 (at 316), determines whether to maintain the particular thermal policy as the current thermal policy of the information handling system 202, at 318. In some examples, the user 250 of the information handling system 202 can provide user input to the information handling system 202 indicating whether to maintain the particular thermal policy as the current thermal policy at the information handling system 202.

In some examples, the thermal policy management computing module 210 determines to maintain the particular thermal policy as the current thermal policy of the information handling system 202 (at 318). For example, the user 250 can provide user input indicating to maintain the particular thermal policy as the current thermal policy of the information handling system 202. To that end, in response to the thermal policy management computing module 210 determining to maintain the particular thermal policy as the current thermal policy (at 318), the thermal policy management computing module 210 maintains the particular thermal policy at the information handling system 202 until a subsequent boot of the information handling system 202, at 320. That is, the particular thermal policy is implemented at the information handling system 202 until a subsequent boot of the information handling system 202, where the method proceeds back to step 302.

In some examples, the thermal policy management computing module 210 determines to not maintain the particular thermal policy as the current thermal policy of the information handling system 202 (at 318). For example, the user 250 can provide user input indicating to not maintain the particular thermal policy as the current thermal policy of the information handling system 202. To that end, in response to the thermal policy management computing module 210 determining to not maintain the particular thermal policy as the current thermal policy (at 318), the thermal policy management computing module 210 reverts to a default thermal policy at the information handling system 202 until a subsequent boot of the information handling system, at 322. That is, the default thermal policy is implemented at the information handling system 202 until a subsequent boot of the information handling system 202, where the method proceeds back to step 302. In some examples, the thermal policy management computing module 210 accesses the thermal table 224 stored by the storage device 212 to identify the default thermal policy. For example, the default thermal policy can correspond to row 552.

In some examples, the thermal policy management computing module 210 determines that the information handling system 202 is associated with a previous thermal policy (at 306). That is, the thermal policy management computing module 210 determines that the historical table 220 does include historical data indicating previous thermal policies at the information handling system 202. For example, thermal policy management computing module 210 determines that the historical table 220 includes a most recent thermal policy implemented at the information handling system 202.

The thermal policy management computing module 210 applies the previous thermal policy at the information handling system 202, at 324. That is, the thermal policy management computing module 210 applies the previous thermal policy at the information handling system 202, including applying the fan curve corresponding with the previous thermal policy, updating the PL2 of the processor 218 corresponding with the previous thermal policy, applying the tau setting corresponding with the previous thermal policy, and applying the temperature trip point corresponding with the previous thermal policy.

In some examples, when the thermal policy management computing module 210 applies the previous thermal policy at the information handling system 202, the thermal policy management computing module 210 adjusts parameters of the cooling component 214, the fan 216, and/or the processor 218. The thermal policy management computing module 210 adjusts the fan curve to correspond with the previous thermal policy, updating the PL2 of the processor 218 to correspond with the previous thermal policy, applying the tau setting to correspond with the previous thermal policy, and applying the temperature trip point to correspond with the previous thermal policy.

Moreover, in some examples, the cooling component 214, the fan 216, and/or the processor 218 operates based on the adjusted parameters. That is, the cooling component 214, the fan 216, and/or the processor 218 operates based on the fan curve corresponding with the previous thermal policy, the PL2 of the processor 218 corresponding with the previous thermal policy, the tau setting corresponding with the previous thermal policy, and the temperature trip point corresponding with the previous thermal policy.

The thermal policy management computing module 210 updates the historical table 220, at 326. Specifically, the thermal policy management computing module 210 updates the historical table 220 to indicate the previous thermal policy as the current thermal policy of the information handling system 202. In other words, the thermal policy management computing module 210 updates the historical table 220 to indicate the previous thermal policy as the most recent thermal policy implemented at the information handling system 202.

The thermal policy management computing module 210, after updating the historical table 220 (at 326), determines whether to maintain the previous thermal policy as the current thermal policy of the information handling system 202, at 328. In some examples, the user 250 of the information handling system 202 can provide user input to the information handling system 202 indicating whether to maintain the previous thermal policy as the current thermal policy at the information handling system 202.

In some examples, the thermal policy management computing module 210 determines to maintain the previous thermal policy as the current thermal policy of the information handling system 202 (at 328). For example, the user 250 can provide user input indicating to maintain the previous thermal policy as the current thermal policy of the information handling system 202. To that end, in response to the thermal policy management computing module 210 determining to maintain the previous thermal policy as the current thermal policy (at 328), the thermal policy management computing module 210 maintains the previous thermal policy at the information handling system 202 until a subsequent boot of the information handling system 202, at 330. That is, the particular thermal policy is implemented at the information handling system 202 until a subsequent boot of the information handling system 202, where the method proceeds back to step 302.

In some examples, the thermal policy management computing module 210 determines to not maintain the previous thermal policy as the current thermal policy of the information handling system 202 (at 328). For example, the user 250 can provide user input indicating to not maintain the previous thermal policy as the current thermal policy of the information handling system 202. To that end, in response to the thermal policy management computing module 210 determining to not maintain the previous thermal policy as the current thermal policy (at 328), the thermal policy management computing module 210 reverts to the default thermal policy at the information handling system 202 until a subsequent boot of the information handling system 202, at 332. That is, the default thermal policy is implemented at the information handling system 202 until a subsequent boot of the information handling system 202, where the method proceeds back to step 302. In some examples, the thermal policy management computing module 210 accesses the thermal table 224 stored by the storage device 212 to identify the default thermal policy. For example, the default thermal policy can correspond to row 552.

In some examples, the thermal policy management computing module 210 determines that thermal policy management is to not be performed at the information handling system 202 (at 304). For example, the user 250 can provide user input indicating to not perform the thermal policy management at the information handling system 202. To that end, in response to the thermal policy management computing module 210 determining that thermal policy management is not to be performed at the information handling system 202 (at 304), the thermal policy management computing module 210 maintains the default thermal policy at the information handling system 202 until a subsequent boot of the information handling system 202, at 334. That is, the default thermal policy is implemented at the information handling system 202 until a subsequent boot of the information handling system 202, where the method proceeds back to step 302.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method of managing thermal policy at an information handling system, including:
detecting a boot of the information handling system;
in response to detecting the boot of the information handling system, performing thermal policy management at the information handling system, including:
determining whether the information handling system is associated with a previous thermal policy based on a thermal diffusivity of cooling components of the information handling system;
determining that the information handling system is not associated with a previous thermal policy, and in response:
determining a particular temperature rise curve of a processor of the information handling system;
identifying a particular thermal diffusivity associated with the particular temperature rise curve;
identifying a particular thermal policy associated with the particular thermal diffusivity;
applying the particular thermal policy at the information handling system, including:
adjusting, based on the particular thermal policy, parameters of the cooling components and the processor; and
operating the cooling components and the processor based on the adjusted parameters.

2. The computer-implemented method of claim 1, further including:
receiving user input indicating to perform the thermal policy management at the information handling system, and in response, performing the thermal policy management at the information handling system.

3. The computer-implemented method of claim 1, further including:
receiving user input indicating to maintain default thermal policy management at the information handling system, and in response, maintaining the default thermal policy management at the information handling system.

4. The computer-implemented method of claim 1, further including:
determining that the information handling system is associated with a previous thermal policy, and in response:
applying the previous thermal policy at the information handling system, including:
adjusting, based on the previous thermal policy, parameters of the cooling components and the processor;
operating the cooling components and the processor based on the adjusted parameters; and
updating a table to indicate the previous thermal policy as the current thermal policy.

5. The computer-implemented method of claim 1, further including:
updating a table to indicate the particular thermal policy as the current thermal policy.

6. The computer-implemented method of claim 5, further including:
after updating the table,
determining whether to maintain the particular thermal policy as a current thermal policy of the information handling system;
determining to maintain the particular thermal policy as a current thermal policy of the information handling system, and in response, maintaining the particular thermal policy at the information handling system until a subsequent boot of the information handling system.

7. The computer-implemented method of claim 5, further including:
after updating the table,
determining whether to maintain the particular thermal policy as a current thermal policy of the information handling system;
determining to not maintain the particular thermal policy as a current thermal policy of the information handling system, and in response, reverting to a default thermal policy at the information handling system until a subsequent boot of the information handling system.

8. An information handling system comprising a processor having access to memory media storing instructions executable by the processor to perform operations, comprising:
detecting a boot of the information handling system;
in response to detecting the boot of the information handling system, performing thermal policy management at the information handling system, including:
determining whether the information handling system is associated with a previous thermal policy based on a thermal diffusivity of cooling components of the information handling system;
determining that the information handling system is not associated with a previous thermal policy, and in response:
determining a particular temperature rise curve of a processor of the information handling system;
identifying a particular thermal diffusivity associated with the particular temperature rise curve;
identifying a particular thermal policy associated with the particular thermal diffusivity;
applying the particular thermal policy at the information handling system, including:
adjusting, based on the particular thermal policy, parameters of the cooling components and the processor; and
operating the cooling components and the processor based on the adjusted parameters.

9. The information handling system of claim 8, the operations further including:
receiving user input indicating to perform the thermal policy management at the information handling system, and in response, performing the thermal policy management at the information handling system.

10. The information handling system of claim 8, the operations further including:
receiving user input indicating to maintain default thermal policy management at the information handling system, and in response, maintaining the default thermal policy management at the information handling system.

11. The information handling system of claim 8, the operations further including:
determining that the information handling system is associated with a previous thermal policy, and in response:
applying the previous thermal policy at the information handling system, including:
adjusting, based on the previous thermal policy, parameters of the cooling components and the processor;
operating the cooling components and the processor based on the adjusted parameters; and
updating a table to indicate the previous thermal policy as the current thermal policy.

12. The information handling system of claim 8, the operations further including:
updating a table to indicate the particular thermal policy as the current thermal policy.

13. The information handling system of claim 12, the operations further including:
after updating the table,
determining whether to maintain the particular thermal policy as a current thermal policy of the information handling system;
determining to maintain the particular thermal policy as a current thermal policy of the information handling system, and in response, maintaining the particular thermal policy at the information handling system until a subsequent boot of the information handling system.

14. The information handling system of claim 12, the operations further including:
after updating the table,
determining whether to maintain the particular thermal policy as a current thermal policy of the information handling system;
determining to not maintain the particular thermal policy as a current thermal policy of the information handling system, and in response, reverting to a default thermal policy at the information handling system until a subsequent boot of the information handling system.

15. A non-transitory computer-readable medium storing software comprising instructions executable by one or more computers which, upon such execution, cause the one or more computers to perform operations comprising:
detecting a boot of the information handling system;
in response to detecting the boot of the information handling system, performing thermal policy management at the information handling system, including:
determining whether the information handling system is associated with a previous thermal policy based on a thermal diffusivity of cooling components of the information handling system;
determining that the information handling system is not associated with a previous thermal policy, and in response:
determining a particular temperature rise curve of a processor of the information handling system;
identifying a particular thermal diffusivity associated with the particular temperature rise curve;
identifying a particular thermal policy associated with the particular thermal diffusivity;
applying the particular thermal policy at the information handling system, including:
adjusting, based on the particular thermal policy, parameters of the cooling components and the processor; and
operating the cooling components and the processor based on the adjusted parameters.

16. The non-transitory computer-readable medium of claim 15, the operations further including:
receiving user input indicating to perform the thermal policy management at the information handling system, and in response, performing the thermal policy management at the information handling system.

17. The non-transitory computer-readable medium of claim 15, the operations further including:
receiving user input indicating to maintain default thermal policy management at the information handling system, and in response, maintaining the default thermal policy management at the information handling system.

18. The non-transitory computer-readable medium of claim 15, the operations further including:
determining that the information handling system is associated with a previous thermal policy, and in response:
applying the previous thermal policy at the information handling system, including:
adjusting, based on the previous thermal policy, parameters of the cooling components and the processor;
operating the cooling components and the processor based on the adjusted parameters; and
updating a table to indicate the previous thermal policy as the current thermal policy.

19. The non-transitory computer-readable medium of claim 15, the operations further including:
updating a table to indicate the particular thermal policy as the current thermal policy.

20. The transitory computer-readable medium of claim 15, the operations further including:
after updating the table,
determining whether to maintain the particular thermal policy as a current thermal policy of the information handling system;
determining to maintain the particular thermal policy as a current thermal policy of the information handling system, and in response, maintaining the particular thermal policy at the information handling system until a subsequent boot of the information handling system.
